(19) United States
(12) Patent Application Publication
(10) Pub. No.: US 2009/0077672 A1
(43) Pub. Date: Mar. 19, 2009

(54) DEPICTION TRANSFORMATION WITH COMPUTER IMPLEMENTED DEPICTION INTEGRATOR

(75) Inventor: Josh Todd Gold, Newport Coast, CA (US)

Correspondence Address: Rutan & Tucker, LLP., 611 ANTON BLVD, SUITE 1400, COSTA MESA, CA, 92626, US

(73) Assignee: Clairvoyant Systems, Inc., Irvine, CA (US)

(21) Appl. No.: 12/233,404

(22) Filed: Sep. 18, 2008

Related U.S. Application Data
(60) Provisional application No. 60/973,721, filed on Sep. 19, 2007.

(51) Int. Cl. H04L 9/32; G06F 17/00

(52) U.S. Cl. 726/27; 715/202

(57) ABSTRACT

Systems and methods providing computer implemented depiction encoding production constructed from one or more depictions, where, for each of one or more depictions, an encoding collection encoding a narrative account is chosen from the depiction, and where, for each chosen encoding collection, an encoding collection is established from the chosen encoding collection, where one or more expression styles from the chosen encoding collection may be replaced with different corresponding expression styles, and where a depiction encoding is assembled from the established encoding collections, such that the narrative account encoded in the assembled depiction encoding is comprised of the narrative accounts of the chosen encoding collections.

### CROSS REFERENCE TO RELATED APPLICATIONS

This application claims priority from U.S. Provisional Patent Application Ser. No. 60/973,721 filed Sep. 19, 2007, which is hereby incorporated herein by reference in its entirety.

### FIELD OF THE INVENTION

This invention relates to the field of production of content for presentation devices. More specifically, the present invention relates to systems and methods for providing rule based depiction transformation.

### DESCRIPTION OF THE RELATED ART

The depiction of a narrative account on presentation devices, such as a display device and a sound output device, for viewers of the narrative account, requires production of content for those presentation devices. The narrative account is represented in an encoded form as a depiction encoding. A depiction decoder translates the depiction encoding into a decoded depiction, where the translating form is compatible with the presentation devices. The decoded depiction may be transmitted to the presentation devices, usually after properly formatting the decoded depiction into a form required by those presentation devices. This decoded depiction determines the depiction of the narrative account that the viewers will experience from the presentation devices.

This application refers to, and utilizes systems and methods described in, U.S. patent application Ser. No. 11/676,922 filed Feb. 20, 2007: “System and Method for the Production of Presentation Content Depicting a Real World Event”, and U.S. patent application Ser. No. 12/101,105 filed Apr. 10, 2008: “Automated Implementation of Characteristics of a Narrative Event Depiction Based on High Level Rules.”

Existing depiction encodings of narrative accounts typically encode the narrative account as a series of video frames and/or a streaming data of one or more audio channels. The video frames and/or audio streams may be further encoded to reduce their size using data compression techniques. Decoding such a depiction encoding into a form suitable for presentation devices is typically a simple process since the encoded form, after undoing any data compression, is not significantly different than the decoded form.

Existing production of a depiction encoding of a narrative account consists of capturing an event using video cameras or other video sources, such as computer or hand drawn animation, and composing the depiction encoding primarily by splicing together a sequence of cuts from the various cameras or other video sources. The depiction encoding is then available for delivery to the depiction consumers, such as on a DVD, in a television or cable broadcast, or as a video file downloaded via the Internet. This distributed depiction is not typically available to be further modified, or at best, can only be modified in only relatively trivial ways. The modifications may be changing video brightness or color contrast and the like. However, the depiction is not modifiable in other desirable ways, such as those involving adding additional cameras, moving the camera to a different position or direction, changing the lighting to reflect a different mood, changing the appearance of an object, or changing the focus zoom of a camera.

The production of a new depiction of a narrative account utilizing material from one or more other depictions is currently limited by the same limitations and specified previously. Typically, all that is available in a new depiction is to piece together existing video and/or audio, possibly including newly captured video and audio data. In effect, this is a depiction consisting of a series of pieces of other depictions. However, this is a severe limitation and results in all new depictions appearing substantially similar to the original depictions.

Prior art depiction encoding forms are also limited by being derived from limited sources. There is little or no control over how the content may be copied or modified when used in other depictions, collectively known as Digital Rights Management (DRM). At best, the depiction encoding form may include copy protection which prevents copying or modification of any part of the content. The precaution may result in preventing use of the content in other depictions. The copy protection is inclusive whereby all the content is copy protected, or none of it is. There is no way to use DRM to distinguish between the parts of the content which may be copied from other parts and which parts may not be used in other depictions.

Prior art depiction encoding forms also severely restrict the ways in which a depiction may utilize other depictions. Content for a depiction must contain all the content used in the depiction. This results in all depictions as independent and complete content packages, no matter what other depictions may be based on. If the content for a depiction is copy protected, then this content may not be used for any other depictions. Further, if a depiction is derived almost unchanged from another depiction, the content for this newly-created derived depiction must include the entire content, possibly with the exception of the small changes, from the original depiction. It is not possible to construct a new depiction as a set of differences one depiction to another.

### SUMMARY OF THE INVENTION

The present invention presents a method and a system for providing a depiction encoding which may be produced from one or more other depictions. For each such other depiction, a portion of the original encoding is selected from changes in expression style of stylistic components. The selected portions are combined to form a resultant depiction encoding. The resultant depiction encoding forms the basis of a narrative account which is essentially narrative accounts of the selected portions of the depiction. For the following descriptions herein, the term “integrator” refers to the above method and the term “integration depiction collection” refers to the above having one or more other depictions. Additionally, the term “integration expression styles” refers to the above changes in expression style of stylistic components and the term “integrated resultant” refers to the resulting depiction encoding of the narrative event.

Exemplary embodiments of the present invention provide for the production of a depiction encoding controlled by a set of predetermined rules. The rules may specify a broad range of control over the process.

In an exemplary embodiment, a computer implemented method for constructing a depiction encoding from at least one depiction, the method comprising the steps of: providing at least one depiction; selecting at least one encoding collection which encodes a narrative account from the at least one depiction, constructing at least one subsequent encoding collection from the at least one selected encoding collection, whereby at least one expression style is optionally superseded in the at least one subsequent encoding collection, assembling a subsequent depiction encoding from the at least one subsequent encoding collection.

In an exemplary embodiment, a method where the subsequent depiction encoding has a depiction encoding form for a VWR depiction decoder.

In an exemplary embodiment, a method wherein the narrative account of the subsequent depiction encoding comprises a real world event.

In an exemplary embodiment, a method where some or all of the steps operate in conjunction with a depiction decoder decoding the subsequent depiction encoding.

In an exemplary embodiment, a method where an expression style is superseded in a subsequent encoding collection using an expression style encoding produced by an automated producer.

In an exemplary embodiment, a method where the subsequent depiction encoding is stored on a data storage device or transmitted to a receiver using a data communication means.

In an exemplary embodiment, a method where the subsequent depiction encoding is produced for a presentation in response to a user request for the presentation.

In an exemplary embodiment, a method where the subsequent depiction encoding is produced according to an integration specification.

In an exemplary embodiment, a method where the integration specification specifies the priority of a plurality of overlapping expression styles, where the overlap comprises a shared stylistic component from the plurality of overlapping expression styles.

In an exemplary embodiment, a method where the integration specification specifies criteria for determining if the configuration of depictions is a valid configuration of depictions.

In an exemplary embodiment, a method where the integration specification criteria specify a plurality of valid configurations of depictions, where at least one valid configuration of depictions comprises a depiction which encodes a narrative account, such that the narrative account is not encoded in any depiction of at least one other valid configuration of depictions.

In an exemplary embodiment, a method where the integration specification criteria specify a narrative account, such that all valid configurations of depictions comprise a depiction encoding the narrative account.

In an exemplary embodiment, a method where the integration specification is represented as part of a numerical data set, and where the numerical data set is stored on a data storage device, retrieved from a data storage device, transmitted using a data communication means, or received using a data communication means.

In an exemplary embodiment, a method where the numerical data set includes at least one depiction.

In an exemplary embodiment, a method where the integration specification is created according to one or more user specified selections via a human interface device.

In an exemplary embodiment, a method where the integration specification is created as a result of modifications made to another integration specification according to user specified selections.

In an exemplary embodiment, a method where an integration specification specifies user specified selection restrictions for one or more elements of the integration specification, where each restriction specifies that the element is modifiable, is not modifiable, or the range of allowable modifications.

In an exemplary embodiment, a method where the modifications occur during a presentation of the subsequent depiction encoding.

In an exemplary embodiment, a method where a plurality of integration packages are indicated to the user, and where an integration package is selected by the user, and where the integration package is the basis of the integration specification and depictions.

In an exemplary embodiment, a method where the selected integration package is modified according to one or more user specified selections.

In an exemplary embodiment, a method where a first integration specification and a first configuration of depictions is selected by a user for a presentation, and where a set of rules determine the establishment of the integration specification and a configuration of depictions based on the first integration specification and first configuration of depictions.

In an exemplary embodiment, a method where the integration specification includes rules controlling DRM restrictions on unauthorized copying or unauthorized use of one or more of the integration specification, one or more depictions, or the subsequent depiction encoding.

In an exemplary embodiment, a method where the integration specification includes rules controlling DRM restrictions on the allowed depictions.

In an exemplary embodiment, a method where the integration specification of a depiction includes rules controlling DRM restrictions on use of one or more of the integration specification of the depiction, or one or more of the depictions of the integration depiction collection of the depiction.

In an exemplary embodiment, a method where the integration specification includes rules controlling DRM restrictions on the allowable modifications of one or more of the integration specification, one or more depictions, or the subsequent depiction encoding.

In an exemplary embodiment, a system for constructing a depiction encoding from one or more depictions, the system comprising: a computational operating mechanism having: receiving at least one depiction, selecting at least one encoding collection which encodes a narrative account from the at least one depiction, constructing at least one subsequent encoding collection from the at least one selected encoding collection, whereby at least one expression style is optionally superseded in the at least one subsequent encoding collection, assembling a subsequent depiction encoding from the at least one subsequent encoding collection, and storing the subsequent depiction encoding.

In an exemplary embodiment, a system further comprising: one or more presentation devices, and a mechanism for producing presentation content for the one or more presentation devices from the subsequent depiction encoding, and a transmission mechanism for transmitting the presentation content to the one or more presentation devices.

In an exemplary embodiment, a computer program product for constructing a depiction encoding from one or more depictions, comprising: computer code that receives at least one depiction, computer code that selects at least one encoding collection which encodes a narrative account from the at least one depiction, computer code that constructs at least one subsequent encoding collection from the at least one selected encoding collection, whereby at least one expression style is optionally superseded in the at least one subsequent encoding collection, computer code that assembles a subsequent depiction encoding from the at least one subsequent encoding collection, and a computer readable medium that stores the computer codes.

In an exemplary embodiment, a computer program product wherein the computer readable medium is a CD-ROM, DVD-ROM, tape, flash memory, system memory, hard drive, or a data signal embodied in a carrier wave.

In an exemplary embodiment, a method wherein the subsequent depiction encoding comprises a set of real world measurement based virtual world values for each real world object from a real world event.

For the following descriptions herein, the term “integration specification” refers to a set of rules, and the term “integration package” refers to an integration specification and a corresponding integration depiction collection. An integration specification may specify the configurations of integration depiction collections which may be used, such as which depictions are allowed, which depictions are not allowed, and which depictions are optional. Such a specification may comprise criteria specifying a class of matching depictions, such as where any depiction matching the class may be used. An integration specification may also specify the portion selected from each depiction of an integration depiction collection, the integration expression styles to be applied, and how the selected portions are combined to form the integrated resultant.

In another exemplary embodiment, the system may provide for a variety of depiction types which may be usable in integration depiction collections. The depiction types may have a depiction encoding, or some other expression of a depiction which may be evaluated to depiction encoding, such as an integration package. Depiction types additionally may have references to the previously mentioned depiction types, rather than the depictions themselves.

In yet another exemplary embodiment, the system may provide for digital rights management protection for the rules controlling production of the integrated depiction encoding, and for the integrated resultant itself. Such protection may restrict copying, control who may use the resource, or how it is used, and may apply to the whole or to part of the resource. A plurality of such protections may apply to a resource.

The present invention provides for substantially expanded depiction option when a plurality of integration specifications are used. For example, the depiction options available for a presentation may depend on the available compatible integration packages and what order of application they are combined with. In an exemplary embodiment, the user configuring the depiction for a presentation may create a customized integration package for that depiction and may use previously saved customized integration packages. Integration specifications or integration packages may also be created, supplied externally or may be supplied by the presentation system. Further, in an exemplary embodiment strict control over multiple aspects of the use of an integration specification, integration package, or integrated resultant may be provided. The control may allow content creators control over how their content is used.

Exemplary embodiments have the ability to process a depiction encoding where the depiction decoder of such depiction encodings utilize a virtual world simulation and produce renderings of the simulation. A depiction encoding for a Virtual World Rendered (VWR) depiction decoder has information about the virtual world of the simulation, information about the incidents occurring in the virtual world during the simulation operation, and information about rendering from the simulation.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the readers understanding of the invention and shall not be considered limiting of the breadth, scope, or applicability of the invention. It should be noted that for clarity and ease of illustration these drawings are not necessarily made to scale.

Features, aspects, and embodiments of the inventions are described in conjunction with the attached drawings, in which:

FIG. 1 is a schematic drawing illustrating an example set of content choices usable by an integrator for the depiction of a narrative account, and several different depictions resulting from different configurations of that content. In some instances, both contents of the depiction encodings and integration specifications.

FIG. 2 is a schematic drawing illustrating example contents of several of the content choices described in FIG. 1.

FIG. 3 is a schematic drawing illustrating an example of some of the depiction options resulting from the combination of the content choices described in FIG. 1.

FIG. 4 is a schematic drawing illustrating an example extensive configuration of the content choices described in FIG. 2.

FIGS. 5A and 5B are a single schematic drawing illustrating an example of the steps taken by the integrator functionality in constructing a integrated resultant from the configuration of content choices described in FIG. 4.

The figures are not intended to be exhaustive or to limit the invention to the precise form disclosed. It should be understood that the invention may include, or be practiced with, modification and alteration, and that the invention be limited only by the claims and the equivalents thereof.

### DETAILED DESCRIPTION OF THE INVENTION

Throughout this description, the preferred embodiment and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

Some of the terms used in the description are definitions in the Term Definitions tables. The terms “user” and “viewer” are used interchangeably for one who views, observes, or is an audience member of the presentation. The term “viewer” commonly refers to visual observation, but may refer to observation using any sense, not just the visual sense.

For illustrative purposes the narrative account used in descriptions of the present invention may be a specific type of narrative account in order to clarify the description. Descriptions in the present invention benefiting from this specific type of narrative account typically use the example of a narrative account of a motor sport race, where the race may be a real world event or a fictional event. As can be appreciated by those of ordinary skill in the art, the systems or methods described are applicable to, any other narrative account without departing from the scope of the invention.

The motor sports race used herein as an example narrative account may represent a real world event, or it may represent a fictional event. The motor sports race involves a plurality of participant vehicles traveling on a race track. The use of the term participant refers to both the human driver of the participant vehicle and the participant vehicle itself. Each participant is a member of a team, and a team may have more than one participant as members. Some example real world events used in descriptive examples in the present invention are from the FASTCAR auto racing series, a fictitious name for a real auto racing series. In actual use of the present invention, the fictitious FASTCAR racing series would instead be an existing real world racing series. The FASTCAR auto racing series, as is typical with racing series, may have the same elements that define the real world racing series including seasons of races, with multiple races per season, multiple teams participating in each race, and one or more drivers per team.

Embodiments of the present invention utilize depiction encoding forms for VWR depiction decoders. Several embodiments of VWR depiction encoding forms and VWR depiction decoder functionality are described in detail in the previously referenced patent applications. In general, the steps for producing a presentation of a narrative account utilizing a VWR depiction decoder comprise:
1) Construct a virtual world representing the world of the narrative account, including the incidents of the narrative account over its time span. Encode this virtual world in the depiction encoding form of the VWR depiction decoder. The virtual world is for use by the simulator(s) of the VWR depiction decoder.
2) Establish rendering information for use in translation of the virtual world to a form suitable for sensory output devices. Encode the rendering information in the depiction encoding form of the VWR depiction decoder. Rendering information is for use by the renderer(s) of the VWR depiction decoder.
3) Produce a VWR depiction encoding of the narrative account comprising the encoded virtual world and encoded rendering information.
4) Distribute or transmit the VWR depiction encoding to the presentation system, where the presentation system operates the VWR depiction decoder and produces presentation content for the presentation device(s) of the presentation of the depiction.
5) Presentation system prepares for VWR depiction decoder operation.
6) Presentation system operates the VWR depiction decoder, comprising operating the simulation, producing renderings from the simulation, and producing presentation content from the renderings. The VWR depiction decoder may additionally comprise a compositor, where renderings or other material for use in presentation content are composited together, and where the presentation content is produced from this composition.
7) Presentation content is transmitted to the presentation devices.

Some parts of these operational steps may overlap in their operation, or may occur in a different order. For example, the presentation system operation is typically concurrent with the transmittal of presentation content to the presentation devices. Operation of elements of embodiments of the present invention typically occurs either during VWR depiction encoding production or within the presentation system during preparation for or operation of the VWR depiction decoder. A simple VWR depiction decoder scenario is described, but other systems may be used. For example, a VWR depiction encoding requiring a plurality of simultaneous simulations, or a VWR depiction encoding with no simulation or renderings for a portion of the depiction, may be produced by another method for that portion.

An exemplary embodiment of the present invention is described herein, giving functionality descriptions, usability descriptions, system and system interaction descriptions, DRM capability and functionality descriptions, and user customization capability and functionality descriptions.

The present invention provides a computer implemented transformation of one or more depictions into a new depiction. An integrator performs the transformation and an integration specification is the set of rules specifying the transformation. The integration depiction collection illustrates one or more depictions and an integrated resultant is the new depiction resulting therefrom.

Embodiments provide for an integration specification not integral to the integrator, such as for an integration specification as a numeric data set separate from the integrator. For example, a relatively generic integrator may be controlled by a given integration specification operating on a given integration depiction collection. Additional embodiments provide for an integration specification comprising the definition and control of expression of the integration expression styles in the integrated resultant. Moreover, an integration specification comprising rules specifying the accepted integration depiction collection configurations, and an integration specification comprising DRM restriction control over itself or the integrated resultant resulting from the use of itself. Other exemplary embodiments utilize components, capabilities, or elements present in, or associated with, a VWR depiction encoding form, such as a VWR depiction encoding and a VWR depiction decoder. The inherent flexibility of a VWR depiction encoding form allows for the capabilities described herein. However, but other depiction encoding forms may also allow for the described capabilities, and use of VWR depiction encoding form related descriptions should not limit the scope of the present invention in any way.

The process of producing an integrated resultant from an integration depiction collection begins with, the depiction of the integration depiction collection. An encoding collection is chosen from the depiction. Methods for choosing, or identifying, an encoding collection may comprise identifying preselected identification from information for the depiction, such as information compiled specifically for the depiction. For example, an encoding collection representing a specific narrative account may be selected from any one of a plurality of depictions comprising the narrative account, wherein the portion of the depiction representing the narrative account is identified by analyzing the structure of the depiction. This may be done by traversing the depiction to identify the simulator information representing the desired narrative account. The structure may be further traversed to identify rendering and other information referenced or utilized by the identified simulator information. Alternately, an encoding collection representing a specific narrative account may be identified using information from a predetermined table, wherein the table contains an entry for each depiction of a plurality of depictions. Each depiction may contain the desired narrative account. Additionally, entry may specify details for identifying the desired encoding collection for that depiction.

An encoding collection may be established from the chosen encoding collection, including expression style changes, where expression styles may be replaced with new expression styles in the established encoding collection. The replacement of an expression style utilizes modifying the encoding collection which uses the established expression style encoding instead of the chosen expression style encoding. The established encoding collection expresses the stylistic component as the established expression style using the established expression style encoding. For example, the establishment of an encoding collection makes a copy of the chosen encoding collection and modifies that copy. The collection encoding may be produced from modifying the chosen encoding collection directly. Methods of producing an established expression style encoding may comprise use of an automated producer of expression style encodings, such as described in the referenced patent application “Automated Implementation of Characteristics of a Narrative Event Depiction Based on High Level Rules.” Algorithms may also be used for producing an expression style encoding. Further, a predetermined expression style encoding, some combination of these methods, or some other method may also be used. For example, for a scene length related stylistic component and corresponding established expression style encoding generated using an automated producer method for a VWR encoding collection, an expression style encoding constituting a scene of a specified scene length may be produced by engaging an automated producer by supplying the appropriate production parameters and receiving in return from the automated producer the expression style encoding.

The integrated resultant is assembled from the established encoding collections. The established encoding collections are assembled into a depiction encoding having the narrative accounts encoded in the established encoding collections. For example, for an integrated resultant which is a VWR depiction encoding and for VWR established encoding collections, the simulator information representing the narrative account of each established encoding collection may be concatenated together in a specific order to present a series of simulations of each established encoding collection. A similar operation may be performed for concatenating the series of instructions for producing renderings from the simulations in order to produce a unified depiction.

Embodiment descriptions where integrator functionality is described as part of a presentation of a depiction encoding are not limiting to the use or scope of integrator functionality only for presentations. Such embodiments are descriptive of some of the possible uses of integrator functionality, and in general, integrator functionality may be independently operable of a depiction decoder or of a depiction encoding production. Embodiments may use independent operation, but may also use dependent operation.

Integrator functionality may have a means to resolve a supersession stylistic component. A supersession stylistic component is a stylistic component whose expression is defined by a plurality of expression styles. This may include stylistic components of a depiction of an integration specification which has a particular expression style defined in that depiction but also has a different expression style defined in the integration specification. The integrator may resolve which expression style to apply to the stylistic component by prioritizing the expression styles, and choosing the highest priority expression style to express in the integrated resultant. The priorities may be specified in an integration specification, or may be specified in a depiction of an integration depiction collection. The priorities may be specified by default to be higher than expression styles specified in a depiction of an integration depiction collection that the integration specifications are applied to.

Integrator functionality may also include a means to resolve integration specification rules specifying that the determination of a valid matching integration depiction collection is required. Such rules may specify a subset of all possible depiction configurations, where only a depiction configuration from the subset of depiction configurations is valid for use with the integration specification. A broad range of criteria may be used by such rules, depending on the needs of the integration specification. For example, the rules may specify a depiction comprising a specific narrative account, such as a depiction of a specific auto race or any auto race of a specified group of auto races, or a depiction comprising a specific resource represented as an encoding collection such as a rendering model for a specified virtual world object.

Integrator functionality may have a means to utilize a depiction of an integration depiction collection. This allows for the capability to produce an integrated resultant from an integration package comprising a plurality of nested integration packages. For example, a depiction from an integration depiction collection may be an integration package, wherein the integration depiction collection from that integration package may include a depiction which is another integration package. Embodiments of nested integration package utilization may comprise intermediate integrated resultant production, intermediate or full integration package production, and combination of some other methods.

Intermediate integrated resultant production may comprise producing integrated resultants from those integration packages which do not comprise an integration package as a depiction of their integration depiction collection and replacing those integration packages with the corresponding integrated resultants. This process is repeated until the depictions of integration depiction collection of the top level integration package no longer have any integration packages. Intermediate integration package production may have merging integration package, wherein a depiction of the integration depiction collection of an integration package is itself an integration package, and where the two integration packages are merged into a single integration package. Merging of integration packages may continue until all nested integration packages are merged together, resulting in a single integration package whose integration depiction collection comprises no integration packages. Full integration package production may be the merger of all nested integration packages without producing intermediate integration packages. Such a merger of integration packages may result in a single integration package whose integration depiction collection has no integration packages.

More complex examples may include combinations of these methods, such as an incomplete full integration package production where possible, followed by intermediate integration package production where possible, followed by incomplete intermediate integration package production where possible, followed by intermediate integrated resultant production where possible, the process continuing using similar methods until a single integration package results.

An integration specification which specifies an integration depiction collection which requires inclusion of a depiction from a specified class of matching depictions is referred to as a dependant integration specification. A depiction from this specified class of matching depictions of a dependant integration specification is referred to as a required depiction. An integration specification that specifies an optional depiction from a specified class of matching depictions is referred to as an enable-able integration specification. A depiction usable for the optional depiction of an enable-able integration specification is referred to as an enabling depiction. An integration specification may be both a dependent integration specification and an enable-able integration specification. An enable-able integration specification may have a plurality of operational modes depending on which enabling depictions are used. Operational modes may comprise different sets of rules for producing an integrated resultant. Operational modes may also have either an enabling depiction absent mode, an enabling depiction present mode or operational modes.

The term integrator input refers to content usable by an integrator. This may include an integration specification, integration depiction collection, integration package, and/or depiction encoding. The source of an integrator input may comprise a source local to the system operating the integrator or a source remote from the system operating the integrator. A local source may include the integrator itself, some other locally operated functionality, or a local storage device. A remote source may have a remote server which supplies the integrator input using a data communications means, such as the Internet or a removable storage media. Sources may supply a partial integrator input. Example sources may include integrator or other local functionality enabling a user to construct an integrator input; integrator or other local functionality enabling automatic construction of integrator input; a commercial or non-commercial remote source for an integrator input; and/or a combination of sources such as advertising supplied from a remote source as an integrator input and utilized in a depiction by local functionality by automatically producing other integrator input which combines the advertising with the depiction to create a new depiction comprising both. It should be clear that the specific examples given are illustrative and should in no way restrict the scope of the invention.

An integrator input may have multiple destinations. An integrator input may be stored for later retrieval using a local storage means, such as a data storage device, or a remote storage means.

An integrator input may be created or modified based on, or may utilize, user specific information or user supplied information, where the user is a viewer of the presentation of a depiction or where the user is associated with the presentation system producing a presentation of a depiction. An example utilizing such a user based integrator input may have a presentation system operating a depiction decoder and an integrator wherein a depiction is selected for presentation and an integration package is created for the purpose of modification of the depiction according to user based information. Another exemplary embodiment may have an integration package with rules based on user based information. Examples of user based information sources may comprise presentation system storage, remote server storage, or remote server supplied information in response to other user based information supplied to the remote server by the presentation system. Examples of a remote server may comprise a subscription server, supplying rights information based on the user, an advertising server supplying advertising based on the user, or a DRM server. Example uses of such user based integrator input for a depiction may comprise, but are not limited to, configuring the depiction to represent either implicit or explicit user preferences, automatically configuring the depiction to a valid configuration, or automatically configuring the depiction to best utilize the presentation system capabilities. Another example may be an integrator input created by the presentation system in response to user input, where the user customizes the selection and configuration of integration specifications or depictions, and where the user may also supply or define more detailed customizations affecting the stylistic components of the depiction. In practice, the user selects a locally available depiction encoding of a narrative account for presentation, the presentation system then configures several possible alternate depictions using other locally available integration specifications and prompts the user with these alternates, then the user selects one of those alternates but makes a change in the configuration and also changes some other lower level stylistic components, such as lighting mood and default camera behavior. The system then uses this configuration to apply additional customizations based on preferences previously specified by the user and then makes additional customizations to maximize the fidelity of the presentation based on the presentation system capabilities. Based on the users subscription level, which indicates that the presentation should contain a certain level and type of advertising, the presentation system contacts an advertising server to receive the latest advertising and targets the user and the narrative account being presented as a set of integrator input and integrates this advertising into the depiction. The depiction is now configured as a nested set of integration packages, and an integrated resultant may be produced by an integrator for presentation by a depiction decoder.

The creator of an integrator input (hereafter referred to as protected content), may wish to exert some level of control over the use of the protected content. A broad range of control is available using DRM functionality integrated with an integrator. DRM functionality controlling use of protected content may use some identifiable aspect of the user or the presentation system such as subscription level, license file, unlock code, or the hardware or software version used for the presentation. The DRM functionality may use an external rights server to determine usage rights, where certain protected content information is supplied to the rights server, and in return receives information indicating how the protected content may be used. The DRM functionality may use DRM information embedded in the encompassing integrator input to determine usage rights. An integrator input which uses DRM protection is not limited to single type of DRM protection, a single instance of DRM protection, or DRM protection coverage of the entire contents. An integrator input using DRM protection may simultaneously use a plurality of different types of DRM protection or a plurality of instances of a particular type of DRM protection, and each instance of DRM protection may cover the entire contents, or some subset thereof. DRM functionality may utilize data encryption, where the protected contents are unusable without decryption of those contents.

Several aspects or methods allow for a large amount of control over how an integrator input is used. DRM is typically usable only to restrict unauthorized copying of content. Additionally, not only is the DRM control broad, but it is deep as well, allowing detailed and complex restriction schemes utilizing specific knowledge of individual aspects of the depiction that are available to the integrator or presentation system.

In a traditional presentation of an narrative account, the presentation system has little or no information of the events that are being depicted, as it only has a series of rectangular grids of colored pixels with which to derive this information from. The situation is considerably different with an embodiment of the present invention using a VWR depiction encoding form. In the present system, the presentation system simulates the depicted events in a virtual world, positions the cameras for the renderings of those events, and renders the objects within the virtual world using models it contains. Much or all of this information is available in the depiction encoding used for a presentation, and this depiction encoding is constructed from a configuration of integrator inputs by an integrator. This broad and deep information about the depiction that will be or is being presented is available for use by the DRM functionality.

DRM functionality may include protected content copy protection whereby unauthorized copies of protected content are prohibited and unusable. For example, a depiction producer copy protects their depiction of a narrative account with DRM copy protection, and sells the depiction encoding as a product. The DRM copy protection insures that each viewer or user must purchase the product in order to view the depiction producers depiction of the event. An independent content producer may then create a modified depiction of the event using references to the depiction producers depiction encoding. This modified depiction may have a dependent integration specification which requires possession of an authorized copy of the depiction producers depiction encoding in order for the dependent integration specification to be used. The independent content producer may choose whether to protect the content without affecting the copy protection of the depiction producers depiction encoding and their copy protected depiction of the narrative account.

DRM functionality may include content use protection, where control is asserted over which other integrator inputs or depictions the protected content may be combined with. Use protection may use criteria to specify a set of integrator inputs or depictions which are allowed or excluded. For example, a sporting event advertiser or sponsor creates integrator input comprising enhanced models, highlighting their brand, comprising a dependent integration specification for use in depictions of the sporting event series they are involved in. They would prefer that their models be used only for depictions of this sporting event series, to prevent their use in other depictions which may not be beneficial to their brand. They therefore include DRM use protection in their dependent integration specification specifying that their dependent integration specification may only be used in combination with a depiction of one of the events in their sporting event series.

DRM functionality may include protected content reuse protection, where control is asserted over the extraction of contents from an integrator input and over which other integrator inputs, depictions, or portions thereof, the extracted content may be combined with. Reuse protection may utilize a specified set of protected subsets of the integrator input wherein the extraction rights are specified for each protected subset. These rights include criteria specifying a set of other contents which are allowed or excluded. For example, an integrator input is produced partially with the use of material which the rights holder wishes not to be used in any other way. The integrator input producer therefore includes DRM reuse protection in their integrator input specifying reuse protection for the protected contents subset comprising the rights holder material, prohibiting extraction of that material for use in other integration packages.

DRM functionality may include protected content modification protection, where control is asserted over the modification of the protected contents of a integrator input. Reuse protection may utilize a specified set of protected subsets of the integrator input, where the modification rights are specified for each protected subset, such modification rights possibly including criteria specifying an allowed or excluded range of modifications. For example, an advertiser pays a depiction producer for inclusion of their brand in the depiction, where the depiction may be a depiction encoding or an integration package. They would prefer that their brand is present and unchanged in all presentations of the depiction, even in presentations where the depiction is combined with overriding integrator inputs which would otherwise alter or remove their brand. The depiction producer therefore includes DRM modification protection in the depiction specifying modification protection for the protected content subset comprising the advertisers brand and various other elements significant for the visibility of that brand.

The present invention allows for a broad range of functionality based on user interaction. The user interaction indicates user preference for a depiction presentation, and integrator functionality may use the indicated user preference to create or modify inputs to reflect that user preference. A user may interact with integrator functionality either before, during, or both before and during, a presentation operation. Before presentation operation or during presentation initiation the user may be prompted for the selection of the narrative account and the depiction of the narrative account to be presented. During presentation performance the user may be prompted to select a different depiction of the narrative account, or to select modifications to the depiction. When changing the depiction of the narrative account based on a user request, the integrator functionality may attempt to continue the presentation while retaining continuity with the previous depiction, such as retaining event time continuity or event view point continuity. During presentation performance the user may also have the ability to select a different narrative account for presentation, which may be essentially the same as stopping the current presentation and initiating user prompting and selection of the narrative account and the depiction of the narrative account as in before the presentation performance.

One embodiment comprises interaction with the user in order to determine the depiction for a presentation, where the presentation system prompts the user for user selection of the narrative account to be presented and for user selection of which depiction of the narrative account to use for the presentation. This embodiment may additionally comprise user selection and configuration of the integrator inputs to use for the presentation. The specifics of this selection and configuration interaction process may be accomplished in a variety of ways, but some generalities can be described. Filtering or sorting of the available integrator inputs and combinations thereof can be used to organize or target the available choices. This filtering or sorting can be based on categories assigned or derived from the integrator inputs and their combinations. Example top level categories may include, but are not limited to, narrative accounts, depictions, depiction encodings, dependent integration specifications, and enable-able integration specifications. Narrative account categories may include, but are not limited to, the narrative account name, narrative account type, and narrative account date. Example narrative account categories may include, in increasing specificity, sporting event, motor sports event, auto racing event, FASTCAR series event, FASTCAR 2007 event, FASTCAR 2007 race #9 event. Depiction categories may include, but are not limited to, MPAA type rating, age appropriate rating, level of violence or language rating, depiction length, depiction style, or various depiction stylistic components. Example depiction style categories may include adult depiction, technical oriented depiction, dramatic depiction, and child oriented depiction.

An example user interaction process for selection and configuration of both the narrative account to be presented and the depiction of that narrative account is described as follows. The user selects one or more initial categories to select from, such as narrative accounts, FASTCAR series events, kids depictions, or kids depictions of FASTCAR series events. The user is shown some representation of the presentations which may be configured to match their selected categories. The user can change their selected categories to adjust the presentations list to match their needs. Descriptions of each presentation in the presentation list are given, with detail appropriate to the category filters selected and the available display area with which to display those details. Additional detail about a listed presentation may be available through user interaction with that listed presentation. As more specific filter categories are selected or specified, more specific lists of presentations are displayed that match those categories. Through this process the user finds a desired presentation from all the available narrative accounts and depictions of those narrative accounts. Typically integrator input not usable using the current user selected filters would not be shown. For example, using a filter based on auto racing events, a dependent integration specification which requires an narrative account which is not an auto race would not be shown. The user may have the option of changing the order of application of integrator inputs, or the user may customize the selected integrator input configuration in other ways, including more complex customizations depending on the functionality available implementing such customization.

An example functional description of the given example user interaction process follows. When the user indicates a request to select a presentation, the presentation system analyzes the available integrator inputs and depiction encodings and forms a list of categories or presentations from those integrator inputs and depiction encodings. This analysis is based on valid integration packages, such that integrator inputs which cannot be part of any integration package constructed from available integrator inputs do not contribute their categories to the list. A similar discrimination is done in the analysis building a list of available presentations, where each presentation listed has sufficient available integrator inputs to build a integration package. The user is prompted with this category or presentation list for selection. User selection resulting in changes to categories may result in additional or more detailed analysis. The user may be prompted with the option to acquire select missing integrator inputs or depiction encodings which would provide additional presentation options. Additional user customizations may require additional user customization functionality. When the user selects a single depiction with no additional user customizations then the presentation system has the information it requires to depict the users requested presentation, including the integration package or depiction encoding to use, their order of application, and any user customizations. The depiction is then available for presentation.

Integrator inputs selected for a presentation, and their selected order of application, may be determined by user selection as described. They may also be determined partially or entirely by non user selectable means. Such non user selectable means may also be used in the determination of which integrator inputs or depiction encodings are allowed for user selection, and how those selected may be configured. These non user selectable means may use selection and configuration requirements explicitly or implicitly defined in the integrator inputs, they may use selection and configuration requirements from user or subscriber information, they may use selection and configuration requirements from the operational characteristics or specifications of the presentation system, or they may use selection and configuration requirements from an external source. Non user selectable determination may utilize the users subscription level or the equivalent, the users preferences or preference history, the presentation system capabilities, the presentation system authorization or equivalent, an external advertising server, or an external authorization or rights server. Non user selectable determination may be used to restrict or control the choices available for user selectable integrator inputs and configurations, as already described, and also to automatically change the integrator inputs selected and their selected configuration. Typically this would involve adding one or more integrator inputs to a configuration in order to satisfy non user selectable configuration requirements. Example uses of non user selectable functionality may include, but are not limited to, including advertising in the presentation, downgrade or restrict some aspect of the depiction, or to provide additional, increased, or more efficient functionality during the presentation. In an example illustrative scenario, during the users integrator input selection and configuration process, the presentation system may not display integrator inputs which the user does not have rights to use, such as not displaying a dependent integration specification which the user has purchased rights to use only on one auto racing series when the user has selected an event from another auto racing series. Further, the presentation system may contact an external rights server and may be notified that the user is not allowed to override certain portions of the depiction, which results in the exclusion of another dependent integration specification. When the user finalizes the selection and configuration of integrator inputs, the presentation system contacts an advertising server, and based on the users subscription level, the advertising server supplies advertising for the presentation in the form of a set of integrator inputs, which are integrated in to the depiction. Next, the presentation system may be determined to be of sufficiently high performance to use the higher fidelity models and renderers, so these, as part of a high fidelity integrator input package, are integrated in as well. It should be clear that the specific non user selectable means described, the specific non user selectable determinations described, and the described illustrative scenario, are illustrative of the narrative account and depiction selection and configuration functionality available using the present invention, and should in no way restrict the scope of the present invention.

Although the present invention has been described with several embodiments and examples, numerous changes, substitutions, variations, alterations, and modifications are possible, including those which should be obvious to one skilled in the art, and it is intended that the invention encompass all such changes, substitutions, variations, alterations, and modifications as fall within the spirit and scope of the included claims, descriptions, and drawings.

The present invention is further described in the diagrams. As described above, the diagrams reference several fictional entities, created to represent what may be real entities in actual practice. The previously described FASTCAR racing series is one such entity. Another such entity is Fastcar Fanatic Productions, an independent production company specializing in products for the FASTCAR series of auto races. Their product line may include integrator inputs. A third entity included in the diagrams is FalconGT, a racing enthusiast who produces integrator inputs of races as a hobby, and provides them to other enthusiasts or viewers at no charge, perhaps through their website. FalconGT does not have the resources to produce depiction encodings requiring licensing of copyrighted or restricted depiction encoding content of a race, so his integrator inputs are dependent integration specifications, dependent on a depiction of the event produced by another depiction producer. FalconGT's shared dependent integration specifications contain no copyrighted or protected material, although they reference such material, and require combination with such material to be used in a presentation.

Example depiction encodings and encoding collections used in the diagrams contain data which may typically be found in a VWR depiction encoding form, comprising various assets for use by functional elements of the depiction decoder to produce their respective products, such as simulator assets defining the events occurring in the virtual world and renderer assets defining the rendered form of virtual world objects, and instructions for controlling the sequence, coordination, and other high level factors of the operation of those functional elements of the depiction decoder to produce the decoded depiction, such as scene definitions for the series of scenes making up the depiction, where each scene definition comprises information determining the virtual world time period to operate the simulation for during the scene and rendering locations within the virtual world from which to produce renderings from during the scene. A typical VWR depiction encoding for a narrative event may comprise simulator assets for the primary events of the narrative account, additional simulator assets for simulating supportive events, renderer assets comprising rendering models for display devices and sound output devices, compositor assets comprising, for example, several different narrations and a musical score, and production instructions consisting of two different predefined depictions. The production instructions are instructions which control the operation of the depiction decoder, comprising instructions controlling the operation of the simulator, instructions controlling the operation of the renderer, and instructions controlling the operation of the compositor. For a VWR depiction encoding of a narrative account, there is a portion representing the events of the narrative account, referred to herein as the core encoding collection. A core encoding collection may typically be comprised of simulator assets, where such simulator assets are the events of the narrative account encoded in a form usable by a simulator. The creator of a core encoding collection is referred to herein as the core content producer.

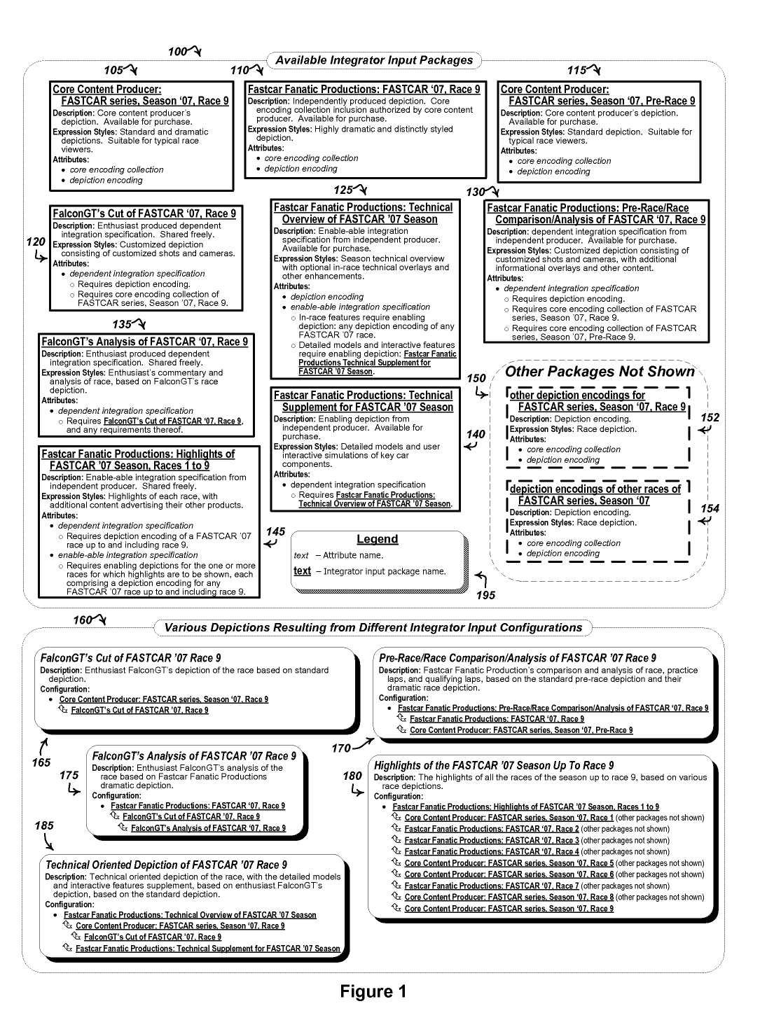

FIG. 1 illustrates an example set of integrator input packages usable for the depiction of an narrative account, namely FASTCAR series season 2007 race number 9, and several different depictions of that narrative account resulting from different configurations of those integrator input packages. The integrator input packages shown are ones which may be available for selection for a presentation on a presentation system, and only those which are usable in a depiction which includes FASTCAR series season 2007 race number 9 are shown. The integrator input packages and configurations shown are an illustrative example set, and not intended to represent all possible such integrator input packages or configurations. Each example integrator input package includes a name, a description of who produced it and if it is sold as a product, a general description of the expression styles it implements, and a list of integrator input attributes from the set of core encoding collection, depiction encoding, dependent integration specification, and enable-able integration specification. A dependent integration specification attribute is followed by a description of the required depiction requirements. An enable-able integration specification attribute is followed by a description of the requirements for each enabling depiction. Each example configured depiction includes a name, a description of the depiction, and a hierarchical list of the configured integrator input packages used in the depiction. The initial bullet point integrator input package is the base package which all other integrator input packages are either applied to or included into. An indented leading arrow indicates that the integrator input package was applied or included into the next less indented integrator input package above.

Legend 195 shows the text formatting used for integrator input attributes and for specific integrator input package names. Integrator input packages 100 are the integrator input packages available for selection for a presentation. The Core Content Producer: FASTCAR series, Season '07, Race 9 package 105 is for the standard and dramatic depictions of the narrative account from the core content producer, who is the source of the core encoding collection for the narrative account. This package is a depiction encoding, usable by the presentation system to produce a presentation without addition of any other encoding collection material. As a depiction encoding of the narrative account, it also contains the core encoding collection. The core content producer sells this package as a product. The depictions in this package are intended to be suitable for typical race viewers. The following descriptions of packages will only explicitly describe aspects of the package which either are not described in the description of the package found in the diagram, or for which understanding is enhanced by additional description. It is assumed that the description of each package found in the diagram is referenced along with the accompanying description here. The Fastcar Fanatic Productions: FASTCAR '07, Race 9 package 110 is a competing depiction of the race and is a depiction encoding. Fastcar Fanatic Productions has licensed use of the core content producers core encoding collection for this narrative account, and have included it in their integrator input. The Core Content Producer: FASTCAR series, Season '07, Pre-Race 9 package 115 is a depiction of the pre-race events, such as race practice laps and race qualifying laps. The FalconGT's Cut of FASTCAR '07, Race 9 package 120 is an enthusiasts depiction of the race, consisting mostly of FalconGT's selection of camera cuts, positions, and targets, and is dependent on a depiction encoding of the race. The Fastcar Fanatic Productions: Technical Overview of FASTCAR '07 Season package 125 is a depiction encoding, containing no core encoding collection, depicting a technical overview of the FASTCAR season. It is also an enable-able integration specification, with additional features enabled with the optional addition of two different enabling depictions. If a depiction encoding of any race in the FASTCAR 2007 season is combined, then various in-race technical oriented features become available, such as actual race depiction examples of various technical overview topics in the season technical overview, or skipping the season technical overview for a technically enhanced depiction of the race. The package includes additional technical oriented models of the cars, including such features as transparent bodies and models for car components otherwise covered by the body, such as the car frame, suspension components, and driveline. The other enabling depiction, the Fastcar Fanatic Productions Technical Supplement for FASTCAR '07 Season package 140, enables additional technical oriented features, such as in-race versions of the previously described technically oriented car models, as well as additional in-race telemetry visualizations, such as 3 axis car acceleration and wheel slip visualizations. This technical supplement package is only usable with Fastcar Fanatic's corresponding technical overview package. The Fastcar Fanatic Productions: Pre-Race/Race Comparison/Analysis of FASTCAR '07, Race 9 package 130 is a dependent integration specification requiring combination with core encoding collection for both race 9, and pre-race 9, and additionally combination with sufficient encoding collection material to constitute a depiction encoding for both the race and pre-race. The depiction is a comparison and analysis between each driver and car performance during the pre-race and during the race. The FalconGT's Analysis of FASTCAR '07, Race 9 package 135 is a dependent integration specification of an enthusiasts commentary on the race. The Fastcar Fanatic Productions: Highlights of FASTCAR '07 Season, Races 1 to 9 package 145 is a dependent integration specification requiring a depiction encoding for at least one race from 1 to 9 from the season. The package depicts highlights from each race it is combined with. The package includes the capability of depicting highlights from only the races run so far in the season, with race 9 being the latest. As additional races occur, the package is updated to include the capability of depicting their highlights as well. The package is an enable-able integration specification, and its enabling depictions are a depiction encoding for each of the first 9 races of the season. Combination with each enabling depiction enables the depiction of highlights from that race. The package producer has elected to distribute the package freely, and has included advertising of their other products in various places in the depiction. Other packages not shown 150 includes other depiction encodings for race 9 152, and depiction encodings for other races in the season 154.

Various depictions resulting from different integrator input package configurations 160 contains several example depictions constructed from the described integrator input packages. Shown are only a few of the many possible depictions. The FalconGT's Cut of FASTCAR '07 Race 9 depiction 165 is FalconGT's depiction based on the core content producers race depiction. The following descriptions of depictions will only explicitly describe aspects of the depiction which either are not described in the description of the depiction found in the diagram, or for which understanding is enhanced by additional description. It is assumed that the description of each depiction found in the diagram is referenced along with the accompanying description here. Pre-Race/Race Comparison/Analysis of FASTCAR '07 Race 9 depiction 170 is a depiction of the pre-race/race comparison/analysis using the core content producers depiction of the pre-race and the independent content producers depiction of the race. FalconGT's Analysis of FASTCAR '07 Race 9 depiction 175 is FalconGT's depiction and commentary of the race based on the independent content producers depiction of the race. Highlights of the FASTCAR '07 Season Up To Race 9 depiction 180 is a depiction of the highlights of all the races in the season from the first to the ninth. The base enable-able integration specification in this case is using all of its enabling depictions. Technical Oriented Depiction of FASTCAR '07 Race 9 depiction 185 is intended for use only as a technically oriented race depiction, and includes an enabling depiction for race 9, consisting of a base depiction of the race and a dependent integration specification depicting FalconGT's depiction of that race. Any race depiction modifications made by the enable-able integration specification will be made to the enabling depiction as a whole, not just to the base race depiction. The other enabling depiction is included as well, with the combination with the technical supplement.

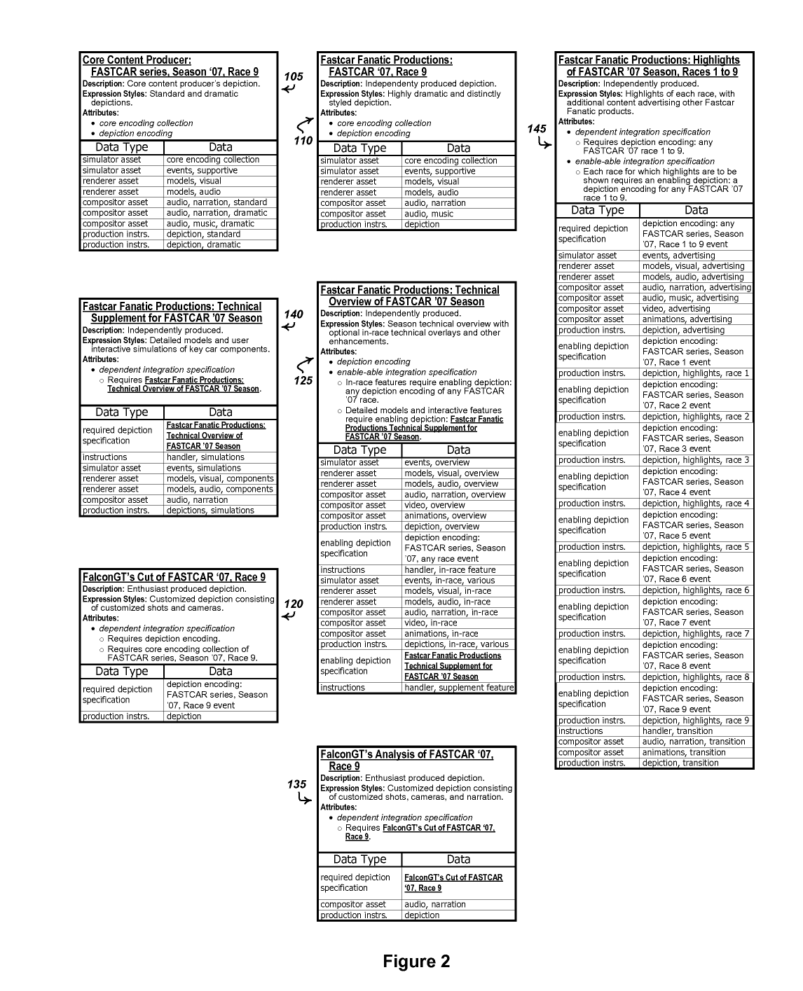

FIG. 2 illustrates example contents of several of the integrator input packages described in FIG. 1. Each example integrator input package includes a name, a description of who produced it, a general description of the expression styles it implements, and a list of integrator input attributes from the set of core encoding collection, depiction encoding, dependent integration specification, and enable-able integration specification. A dependent integration specification attribute is followed by a description of the required depiction requirements. An enable-able integration specification attribute is followed by a description of the requirements for each enabling depiction. Following the attribute list is a summary listing of likely contents with which the integrator input is composed. For each such content listed, the Data Type column contains a more specific description of the content type, and the Data column contains a description of the data for this content. This listing of integrator input contents is not meant to be complete, and other material may be included, including content material dealing with DRM and other functionality available using the presentation system. The following descriptions of the integrator input packages will only explicitly describe aspects of the package which either are not described in the description of the package found in the diagram, not described in the description of the package found in the description for FIG. 1, or for which understanding is enhanced by additional description. It is assumed that the description of each package found in the diagram is referenced along with the accompanying description here and the description of the package found in the description for FIG. 1 and in FIG. 1.

The Core Content Producer: FASTCAR series, Season '07, Race 9 package 105 comprises a core encoding collection for the race, additional simulator assets for simulating supportive events not captured as part of the core encoding collection, renderer assets consisting of rendering models for display devices and sound output devices, compositor assets consisting of two different narrations and a musical score, and production instructions consisting of two different predefined depictions. The Fastcar Fanatic Productions: FASTCAR '07, Race 9 package 110 comprises a core encoding collection for the race, additional simulator assets for simulating supportive events not captured as part of the core encoding collection, renderer assets consisting of rendering models for display devices and sound output devices, compositor assets consisting of a narration and a musical score, and production instructions consisting of a predefined depiction. The FalconGT's Cut of FASTCAR '07, Race 9 package 120 comprises a required depiction specification, as this package is a dependent integration specification requiring combination with other encoding collection material, and production instructions consisting of a predefined depiction. The required depiction specification is a set of rules for the integrator functionality of the presentation operation. The Fastcar Fanatic Productions: Technical Overview of FASTCAR '07 Season package 125 comprises encoding collections for the season overview depiction, and encoding collections for implementation of each enabling depiction. The season overview encoding collections comprise simulator assets for simulating the season overview, renderer assets for use in rendering the season overview simulation, consisting of rendering models for display devices and sound output devices, compositor assets consisting of a narration, various videos such as previous season racing highlights and interviews with team personnel, and various descriptive animations, and production instructions consisting of a predefined depiction of the season overview. The race event enabling depiction portion comprise an enabling depiction specification specifying the valid matching enabling depictions, and a list of encoding collections for implementing the in-race features of this integrator input in the supplied enabling depiction. The enabling depiction specification is a set of rules for the integrator functionality of the presentation operation. The list of the contents for implementing the in-race features of this integrator input in the supplied enabling depiction comprises instructions for handling the integration of the in-race features, simulator assets for simulating the various in-race features, renderer assets for use in rendering various in-race features, consisting of rendering models for display devices and sound output devices, compositor assets consisting of a narration, various videos, and various descriptive animations, and production instructions consisting of a predefined depictions of various in-race features. The technical supplement enabling depiction portion comprises an enabling depiction specification specifying the valid matching enabling depictions, and instructions for handling the integration of the technical supplement features. The Fastcar Fanatic Productions Technical Supplement for FASTCAR '07 Season package 140 comprises a required depiction specification specifying the valid matching required depictions, instructions for handling the integration of the technical supplement features, simulator assets for simulating the various technical supplement features, renderer assets for use in rendering various technical supplement features, consisting of rendering models for display devices and sound output devices, compositor assets consisting of a narration, and production instructions consisting of a predefined depictions of various technical supplement features. The FalconGT's Analysis of FASTCAR '07, Race 9 package 135 comprises a required depiction specification, compositor assets consisting of a narration, and production instructions consisting of a predefined depiction. The Fastcar Fanatic Productions: Highlights of FASTCAR '07 Season, Races 1 to 9 package 145 comprises a required depiction specification, specifying the minimum encoding collection material which the package must be combined with, a list of encoding collections for implementing the advertising portion of the depiction, an enabling depiction specification and production instructions consisting of a predefined depiction for each of the nine enabling depictions, and a list of encoding collections for implementing the depiction as a whole. The list of encoding collections for implementing the advertising portion of the depiction comprises simulator assets for simulating the advertisements, renderer assets for use in rendering the advertisements, consisting of rendering models for display devices and sound output devices, compositor assets consisting of advertising narrations, music, videos, and animations, and production instructions consisting of predefined depictions of various advertising depictions. In this example, the advertising is integrated into the highlights depiction, appearing both within the race highlights and as separate advertisement scenes, as well as in the between race transition segments. Optional functionality not shown includes disabling the advertisements if certain other integrator inputs from this content producer have been purchased by the user. The list of contents for implementing the depiction as a whole comprises instructions for handling implementation of the transitional segments before, between, and after race highlights for a race, compositor assets consisting of various narrations and animations for the transitional segments, and production instructions consisting of predefined depictions of the transitional segments.

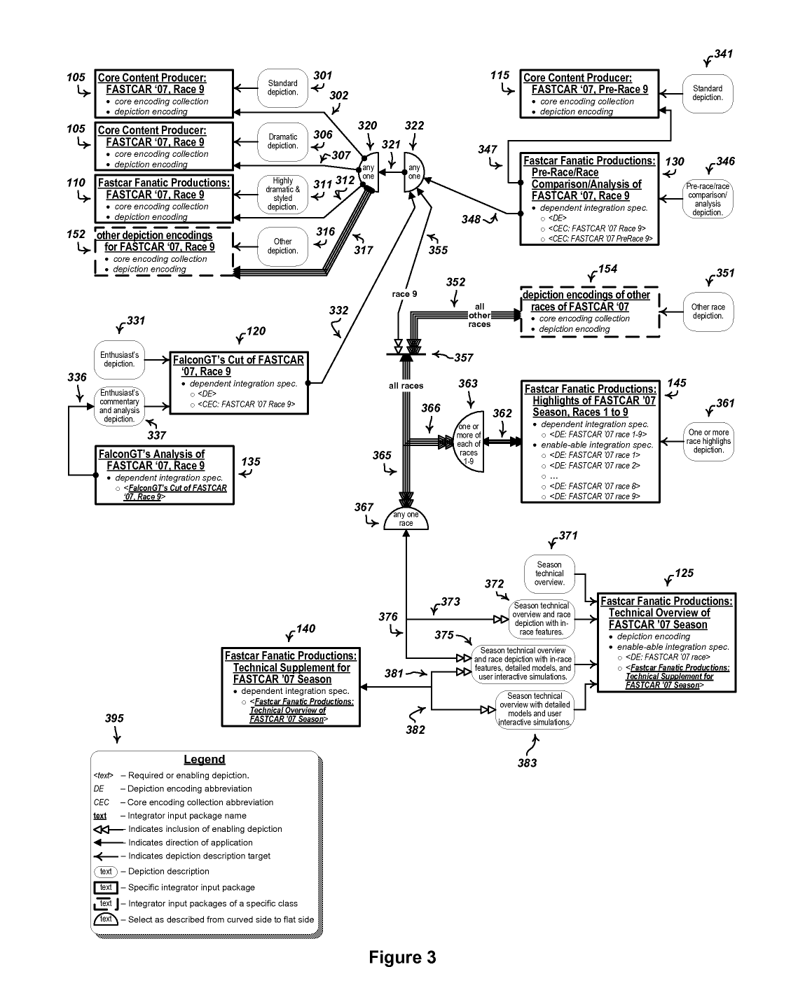

FIG. 3 illustrates some basic depiction options resulting from combinations of the integrator input packages described in FIG. 1. The combinations are illustrated with representations of the integrator input packages, depiction descriptions, and various elements representing the valid package configurations. More extensive integrator input configurations and customizations, such as depictions consisting of additional levels of configurations, or using user customizations, are not shown in this diagram. Each integrator input package includes a name, and a list of integrator input attributes from the set of core encoding collection, depiction encoding, dependent integration specification, and enable-able integration specification. A dependent integration specification attribute is followed by a description of the required depiction requirements. An enable-able integration specification attribute is followed by a description of the requirements for each enabling depiction. The following descriptions of the depiction options will only explicitly describe aspects of the depiction options which either are not described in the description of the package found in the diagram, not described in the description of the package found in the descriptions for FIG. 1 or FIG. 2 or within those diagrams, or for which understanding is enhanced by additional description. It is assumed that the description of depiction options found in the diagram is referenced along with the accompanying description here and the description of the package found in the descriptions for FIG. 1 and FIG. 2 and within those diagrams. Legend 195 shows the text formatting used for integrator input attributes and for specific integrator input package names, abbreviations used in the descriptions of required and enabling depictions, and various shapes and symbols. The double open arrow indicates the direction of an enabling depiction added to an enable-able integration specification. The solid single arrow indicates the direction of application of an integrator input to another.

The standard depiction 301 and dramatic depiction 306 from Core Content Producer: FASTCAR series, Season '07, Race 9 package 105, the depiction 311 from Fastcar Fanatic Productions: FASTCAR '07, Race 9 package 110, and other depictions 316 from other depiction encodings for FASTCAR '07, Race 9 152 are the most basic depiction options of race 9. Any one of these four depictions may be used as a required or enabling depiction as indicated by the paths 302, 307, 312, and 317 connecting to selector 320. This selector selects one of these depictions, connecting the selected depiction via path 321 to selector 322, which connects to one of the dependent or enable-able integration specifications.

The enthusiasts depiction 331 from FalconGT's Cut of FASTCAR '07, Race 9 package 120 uses any one of the aforementioned race 9 depictions as a required depiction via path 332. The enthusiasts commentary and analysis depiction 337 from FalconGT's Analysis of FASTCAR '07, Race 9 package 135 uses FalconGT's Cut of FASTCAR '07, Race 9 package as a required depiction via path 336.

The standard depiction of pre-race 9 341 from Core Content Producer: FASTCAR series, Season '07, Pre-Race 9 package 115 is the most basic depiction option of pre-race 9. The pre-race/race comparison/analysis depiction 346 from Fastcar Fanatic Productions: Pre-Race/Race Comparison/Analysis of FASTCAR '07, Race 9 package 130 uses the Core Content Producer: FASTCAR series, Season '07, Pre-Race 9 package as a required depiction via path 347, as well as any one of the aforementioned race 9 depictions as the other required depiction via path 348.

Other race depictions 351 from depiction encodings of other races of FASTCAR '07 154 are available depictions, and available for use as enabling or required depictions via path 352. These race depictions of FASTCAR season 2007 races other than race 9 are available in combination with a race 9 depiction, via path 355, indicated with the combiner 357. This combination represents the availability of all available depictions of all available races for FASTCAR season 2007.

The race highlights depiction 361 from Fastcar Fanatic Productions: Highlights of FASTCAR '07 Season, Races 1 to 9 package 145 uses one depiction each of any combination of races from race 1 to 9, via path 362 selecting one or more race depictions as enabling depictions at selector 363, via the available race depictions 366.

The season technical overview depiction 371 from the enable-able integration specification Fastcar Fanatic Productions: Technical Overview of FASTCAR '07 Season package 125 requires combination with no other integrator inputs. Additional depictions and functionality are available when the enable-able integration specification is combined with one or both enabling depictions. The enable-able integration specification combined with the enabling depiction of any one race depiction, via path 373, from the single race selector 367 of all available FASTCAR 2007 season race depictions via path 365, results in a depiction of the race with in-race technical features 372 in addition to the season technical overview depiction. The enable-able integration specification combined with the enabling depiction Fastcar Fanatic Productions Technical Supplement for FASTCAR '07 Season package 140, via path 382, results in a depiction of the season technical overview with the addition of detailed models and user interactive simulation features 383. The enable-able integration specification combined with both above enabling depictions, via paths 376 and 381, results in a depiction 375 as described above for each enabling depiction, in addition to additional detailed models for use in the race depiction.

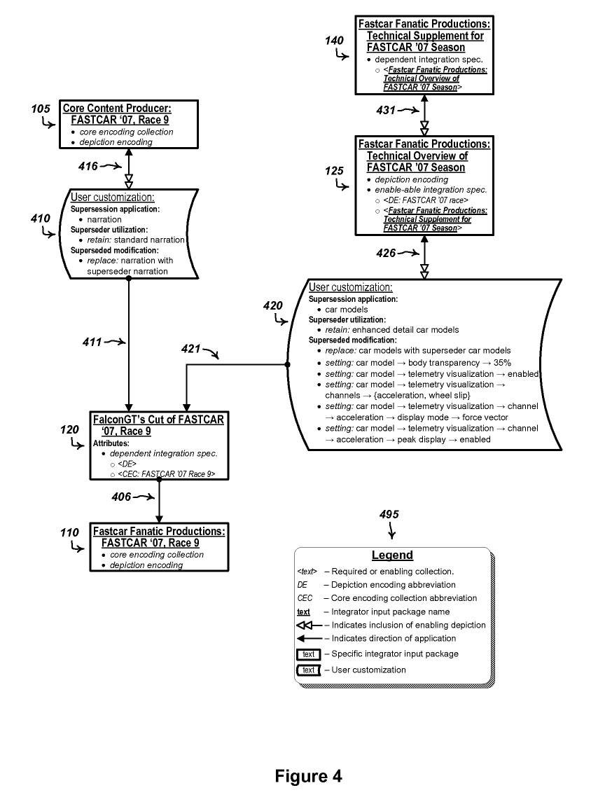

FIG. 4 illustrates a more extensive example integrator input configuration of the integrator input packages described in FIG. 2. This configuration uses a valid combination of integrator input packages, as described in the schematic of FIG. 3, as well as additional user customizations, comprising user customization based integration specifications, and application of these user customization based integration specifications with other integrator input packages. The combination is illustrated with representations of the integrator input packages, user customization based integration specifications, dependent integration specification application direction, and enabling depiction inclusion direction. Each user customization group includes a description of the supersession stylistic components of the application which the user customization represents, a description of how the superseder encoding collection is utilized in this application, and a description of how the superseded encoding collection is modified by this application. The superseder utilization description includes a description of the encoding collection retained from the referenced integrator input packages. The superseded modification description includes a description of what encoding collections in the superseded encoding collection are replaced with the retained encoding collection from the referenced integrator input packages, and descriptions of any user specified settings which are applied. Each integrator input package includes a name, and a list of integrator input attributes from the set of core encoding collection, depiction encoding, dependent integration specification, and enable-able integration specification. A dependent integration specification attribute is followed by a description of the required depiction requirements. An enable-able integration specification attribute is followed by a description of the requirements for each enabling depiction. The following descriptions will only explicitly describe aspects which either are not described in the description of the package found in the diagram, not described in the description of the package found in the descriptions for FIG. 1, FIG. 2, or FIG. 3 or within those diagrams, not described in the description of the configuration options found in the description for FIG. 3 or within that diagram, or for which understanding is enhanced by additional description. It is assumed that the descriptions found in the diagram are referenced along with the accompanying description here and the descriptions found in the descriptions for FIG. 1, FIG. 2, and FIG. 3 and within the diagrams themselves. Legend 495 shows the text formatting used for integrator input attributes and for specific integrator input package names, abbreviations used in the descriptions of required and enabling depictions, and various shapes and symbols. The double open arrow indicates the direction of an enabling depiction added to an enable-able integration specification. The solid single arrow indicates the direction of application of an integrator input to another.

The depiction configured by the user, in summary, depicts FalconGT's depiction of Fastcar Fanatic's FASTCAR '07 race 9 depiction, but with FalconGT's narration replaced with the standard narration from the core content producers depiction of the same race. Further, the car models used in the race are replaced with the detailed models found in Fastcar Fanatic's Technical Supplement, and various features available with those detailed car models are enabled and configured. These enabled and configured detailed car model features include enabling car body transparency and setting it to 35%, so that internal frame, suspension, driveline, and other components are visible, enabling telemetry visualization, enabling acceleration and wheel slip telemetry channel visualizations, setting the acceleration telemetry visualization mode to force vector mode, and enabling peak display for the acceleration telemetry visualization. Available for use from the Technical Supplement, but not shown and not used in this depiction, are additional detailed car model features, including addition telemetry visualization channels, additional telemetry visualization display modes, and other features. It should be clear to any practitioner of ordinary skill in the art that the specific user customizations and integrator input features described are illustrative of the functionality available using the present invention, and should in no way restrict the scope of the present invention.

The configured depiction is based on Fastcar Fanatic Productions: FASTCAR '07, Race 9 package 110, with FalconGT's Cut of FASTCAR '07, Race 9 package 120 applied 406. The user has chosen a race depiction using another narration, replacing the narration from the FalconGT's Cut of FASTCAR '07, Race 9 package, which in turn replaced the narration from the Productions: FASTCAR '07, Race 9 package. The users chosen narration is from Core Content Producer: FASTCAR series, Season '07, Race 9 package 105, and this user customization is implemented by the use of a user customization based integration specification 410 referencing 416 the integrator input containing the needed encoding collection material and specifying that only the encoding collection material needed for the narration be applied 411 to the base depiction. The users chosen car model customization is similarly applied. The car models needed are contained within Fastcar Fanatic Productions Technical Supplement for FASTCAR '07 Season package 140, but this package is only usable as a dependent integration specification of Fastcar Fanatic Productions: Technical Overview of FASTCAR '07 Season package 125, so those two packages are combined together 431 in that configuration. User customization based integration specification 420 references this configuration 426, specifying that only the encoding collection material needed for the in-race detailed car models are applied 421 to the base depiction. This application replaces use of the car models within the Fastcar Fanatic Productions: FASTCAR '07, Race 9 package which would have otherwise been used, noting that the FalconGT's Cut of FASTCAR '07, Race 9 package does not contain any such car models. This user customization based integration specification further customizes the use of the detailed car models, enabling capabilities and setting values of the detailed car models, as specified by the user.

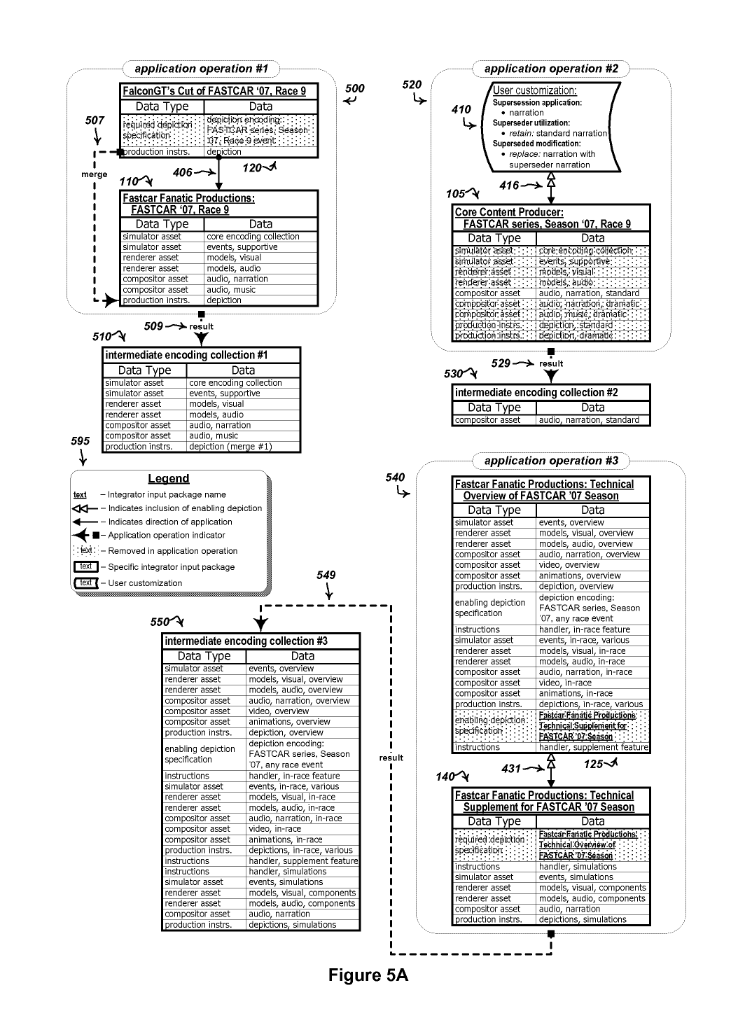

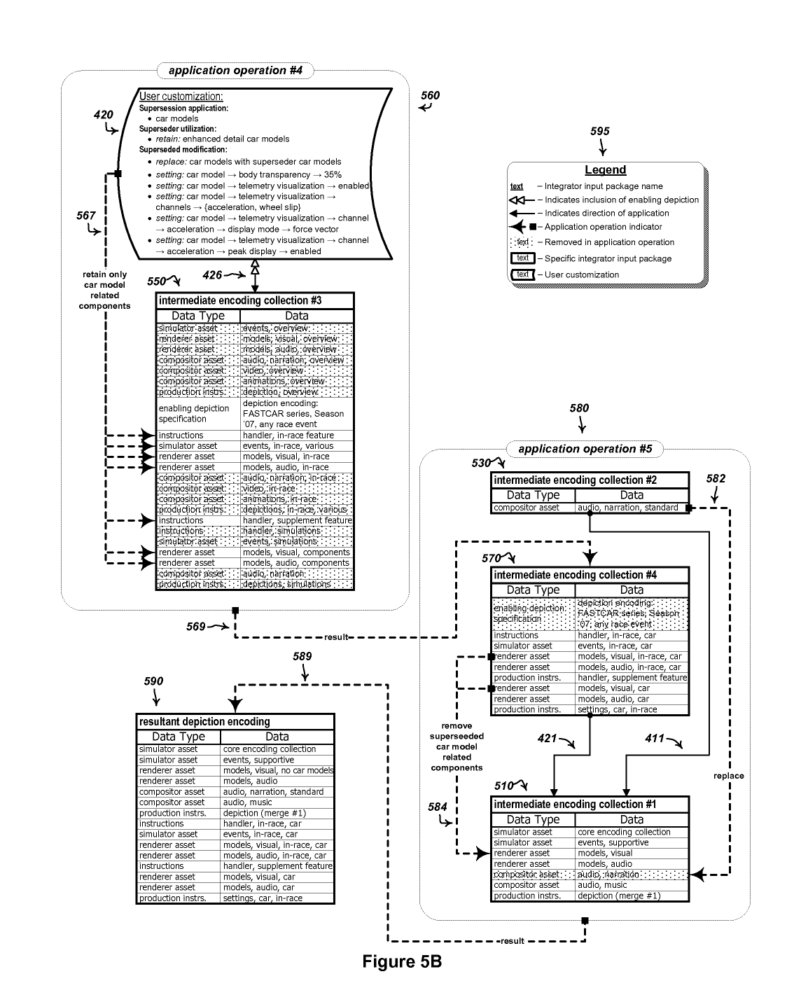

FIGS. 5A and 5B together illustrate an example of the steps taken in constructing a single depiction encoding from the configuration of integrator input packages described in FIG. 4. Limitations on drawing size required the drawing be split across two diagrams, and hereafter those two diagrams will be considered as a single drawing. The diagram is illustrated with representations of the integrator input packages, intermediate encoding collections, the depiction encoding, user customization based integration specifications, dependent integration specification application direction, enabling depiction inclusion direction, and application operations. Each user customization group includes a description of the supersession stylistic components of the application which the user customization represents, a description of how the superseder encoding collection is utilized in this application, and a description of how the superseded encoding collection is modified by this application. The superseder utilization description includes a description of the encoding collection retained from the referenced integrator input packages. The superseded modification description includes a description of what encoding collections in the superseded encoding collection are replaced with the retained encoding collection from the referenced integrator input packages, and descriptions of any user specified settings which are applied. Each example integrator input package includes a name, and each integrator input package, intermediate encoding collection, and depiction encoding includes a summary listing of likely contents with which it is composed. For each such content listed, the Data Type column contains a more specific description of the type, and the Data column contains a description of the data. This listing of integrator input package, intermediate encoding collection, and depiction encoding contents is not meant to be complete, and other contents may be included, including those dealing with DRM and other functionality available using the presentation system. The following description will only explicitly describe aspects which either are not described in the descriptions of the integrator input packages found in the description for FIGS. 1 through 4 or within the diagrams themselves, not described in the descriptions of the user customizations found in the description for FIG. 4 or within that diagram, or for which understanding is enhanced by additional description. It is assumed that the description is referenced along with the descriptions found in the descriptions for FIGS. 1 through 4 and within those diagrams. Legend 595 shows the text formatting used for specific integrator input package names, and various shapes and symbols. The double open arrow indicates the direction of an enabling depiction added to an enable-able integration specification. The straight sided solid single arrow indicates the direction of application of a integrator input to another. The curved sided solid single arrow indicates an individual application operation, applied from the source location indicated by the solid square to the destination location indicated by the arrow. It should be clear to any practitioner of ordinary skill in the art that the specific integrator input package contents, intermediate encoding collection contents, the depiction encoding contents, user customizations, integrator input features, application operations, and the construction steps taken are used to illustrate the functionality available using the present invention, and should in no way restrict the scope of the present invention.

The construction steps comprise three independent application operations, which are order independent amongst themselves, each producing an intermediate encoding collection, then an application operation relying on one of those intermediate encoding collections, producing another intermediate collection, then a final application operation involving the remaining three unused intermediate encoding collections, producing the resultant depiction encoding.

Application operation #1 500 consists of the application 406 of FalconGT's Cut of FASTCAR '07, Race 9 package 120 to Fastcar Fanatic Productions: FASTCAR '07, Race 9 package 110. The combination of the dependent integration specification with the given required depiction is checked against the required depiction specification, and the given required depiction is found to be a valid match. The dependent integration specification production instructions controlling the depiction are merged 507 into the production instructions of the required depiction, where supersession stylistic components between the dependent integration specification and required production instructions are determined by the superseder encoding collection, which is the dependent integration specification. The result 509 of this application operation is the intermediate encoding collection #1 510, with the merged production instructions as indicated.

Application operation #2 520 consists of the combination 416 of user customization based integrator input 410, the enable-able integration specification, with Core Content Producer: FASTCAR series, Season '07, Race 9 package 105, the enabling depiction. The user customization uses only the standard narration from the enabling depiction and discards the rest, resulting 529 in intermediate encoding collection #2 530.

Application operation #3 540 consists of the combination 431 of Fastcar Fanatic Productions: Technical Overview of FASTCAR '07 Season package 125, the enable-able integration specification or required depiction, with Fastcar Fanatic Productions Technical Supplement for FASTCAR '07 Season package 140, the enabling depiction or dependent integration specification. The combination of the enable-able integration specification with the given enabling depiction is checked against the enabling depiction specifications in the enable-able integration specification, and the given enabling depiction is found to be a valid match with one of those enabling depiction specifications. The combination of the dependent integration specification with the given required depiction is checked against the required depiction specification in the dependent integration specification, and the given required depiction is found to be a valid match. The two integrator inputs are then combined as previously described, with the enable-able integration specification as the superseder encoding collection. The enabling depiction specification not matched with an enabling depiction is included in this combination, resulting 549 in intermediate encoding collection #3 550.

Application operation #4 560 consists of the combination 426 of user customization based integration specification 420, the enable-able integration specification, with intermediate encoding collection #3 550, the enabling depiction. The user customization uses only the in-race detailed car models and supporting functionality from the enabling depiction 567 and discards the rest, resulting 569 in intermediate encoding collection #4 570.

The final application operation, application operation #5 580, consists of two applications. The application 411 of intermediate encoding collection #2 530 to intermediate encoding collection #1 510 replaces 582 the narration in intermediate encoding collection #1 with the narration in intermediate encoding collection #2. The application 421 of intermediate encoding collection #4 570 to intermediate encoding collection #1 replaces 584 the car model components in intermediate encoding collection #1 with the car model components in intermediate encoding collection #4. These two applications result 589 in the resultant depiction encoding 590, usable for the presentation of the depiction and implementing the expression styles of the users customized configuration. This depiction encoding comprises the core encoding collection, supportive events, visual models not including car models, audio models, and music from the Fastcar Fanatic Productions: FASTCAR '07, Race 9 package, narration from the Core Content Producer: FASTCAR series, Season '07, Race 9 package, in-race car handler, in-race car events, in-race car visual models, in-race car audio models, and the supplementary feature handler from the Fastcar Fanatic Productions: Technical Overview of FASTCAR '07 Season package, additional car audio models and car visual models from the Fastcar Fanatic Productions Technical Supplement for FASTCAR '07 Season package, in-race car model settings from one of the customization based integration specifications, and production instructions for controlling the depiction from the merger of the dependent integration specification with the required depiction in application operation #1.

The specific described choices for systems, methods, components, mechanisms, functionality, and algorithms with respect to the preferred embodiment of the present invention is primarily for simplicity, and any practitioner of ordinary skill in the art can clearly see that alternate said choices could be substituted at any point without changing the scope or originality of the present invention.

Unless defined otherwise, all technical and scientific terms used herein have the same meaning as is commonly understood by one of ordinary skill in the art to which this invention belongs. All patents, applications, published applications and other publications referred to herein are incorporated by reference in their entirety. If a definition set forth in this section is contrary to or otherwise inconsistent with a definition set forth in applications, published applications and other publications that are herein incorporated by reference, the definition set forth in this section prevails over the definition that is incorporated herein by reference.

While various embodiments of the present invention have been described above, it should be understood that they have been presented by way of example only, and not of limitation. Likewise, the various diagrams may depict an example architectural or other configuration for the invention, which is done to aid in understanding the features and functionality that may be included in the invention. The invention is not restricted to the illustrated example architectures or configurations, but the desired features may be implemented using a variety of alternative architectures and configurations. Indeed, it will be apparent to one skilled in the art how alternative functional, logical, or physical partitioning and configurations may be implemented to include the desired features of the present invention. Also, a multitude of different constituent module names other than those depicted herein may be applied to the various partitions. Additionally, with regard to flow diagrams, operational descriptions, and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead may include applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional”, “traditional”, “normal”, “standard”, “known”, and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements, or components of the invention may be described or claimed in the singular, the plural is contemplated to be within the scope thereof unless limitation to the singular is explicitly stated. Likewise, although items, elements, or components of the invention may be described or claimed in the plural, the singular is contemplated to be within the scope thereof unless limitation to the plural is explicitly stated.

The presence of broadening words and phrases such as “one or more”, “at least”, “but not limited to”, or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and can further be distributed in multiple groupings or packages or across multiple locations.

Basic Depiction Term Definitions

| Term | Definition |
|---|---|
| incident | A collection of one or more real or fictional acts or occurrences. |
| | Examples may include a real car crash event, a specific moment |
| | from the real car crash event, such as the moment of first contact, or |
| | a fictional encounter between two fictional characters. |
| narrative account | A message that tells the particulars of a set of incidents, such as the |
| | telling of a story or an account of events. Examples may include a |
| | real or fictional motor sports race event, or some other real or |
| | fictional story. |
| depiction | An expression of a narrative account, where said expression is |
| | characterized by a depiction style. Examples may include a real or |
| | fictional motor sports race event expressed in the style of a televised |
| | broadcast using stationary cameras, or in the style of a dramatic |
| | movie using dynamic cameras. |
| depiction decoder | A means to decode a depiction encoding conforming to a depiction |
| | encoding form in to a form suitable for presentation devices. |
| | Examples may include algorithms for decoding MPEG-4 encodings |
| | to a video display device and stereo audio device, or algorithms for |
| | decoding a VWR depiction encoding, a form for representing a |
| | depiction in the form of a virtual world and renderings from that |
| | virtual world, where the algorithms operate the virtual world |
| | according to the encoding, and perform renderings from that virtual |
| | world according to the encoding, where the renderings are for a |
| | video display device and a surround sound audio device. |
| presentation | The performance of a depiction of a narrative account from a |
| | depiction encoding by a depiction decoder, where said performance |
| | is for reception by an audience, and where said performance is |
| | presented for said reception on one or more presentation devices. |
| | Examples may include a computer operated multimedia player |
| | software program playing an MPEG-4 video of a movie presented |
| | on a video monitor and stereo speakers, or a computer operated |
| | VWR depiction decoder program playing a VWR depiction |
| | encoding of a movie presented on a video monitor and stereo |
| | speakers. |
| depiction encoding form | The form which a depiction encoding must conform to in order to |
| | be compatible with a depiction decoder. Examples may include a |
| | data format conforming to the MPEG-4 digital audio and video |
| | coding format, or a data format for representing a depiction in the |
| | form of a virtual world and renderings from that virtual world. |
| depiction encoding | A depiction of a narrative account represented in a tangible form as |
| | a numeric data set, where the narrative account and depiction style |
| | of said depiction are encoded in said numeric data set in the |
| | depiction encoding form of a depiction decoder. Examples may |
| | include a MPEG-4 video file, or a numeric data set conforming to a |
| | VWR depiction encoding form containing virtual world operation |
| | information and information for rendering from that virtual world |
| | while in operation. |
| stylistic component | A component of a narrative account which may be expressed in any |
| | of a plurality of expression styles without changing the meaning of |
| | the narrative account, where the target of the expression of said |
| | component is an audience of a presentation. Examples may include |
| | the sequence of scenes with which the narrative account is |
| | presented, characteristics for each camera and for each audio |
| | counterpart to a camera, such as position and movement path, |
| | artistic resources, such as lighting, music, and commentary, event |
| | element depictive resources, such as object models and sound |
| | effects, and rendering style. |
| expression style | The manner of expression for a stylistic component of a narrative |
| | account. An example may include the difference in the expression |
| | of a stylistic component between two different movies of the same |
| | narrative account. |
| depiction style | The set of one or more expression styles of a depiction. An |
| | example may include the difference in the expression of a narrative |
| | account between two different movies of the same narrative |
| | account. |
| expression style | An expression style represented in a tangible form as a numeric data |
| encoding | set, where the expression style is encoded in said numeric data set in |
| | the depiction encoding form of a depiction decoder, such that said |
| | numeric data set may be used as part of a depiction encoding as an |
| | expression style of the depiction style of said depiction encoding. |
| | Examples may include, for a VWR depiction encoding form, a |
| | series of virtual world operation directives, determining a series of |
| | scenes, or a set of rendering models, determining the appearance of |
| | an object from the virtual world. |
| encoding collection | A numeric data set encoded in the depiction encoding form of a |
| | depiction decoder. Examples may include a subset or subsets of |
| | one or more depiction encodings or expression style encodings. |
| decoded depiction | The decoded depiction encoding from the operation of a depiction |
| | decoder. Examples may include a series of video frames and a set |
| | of audio signals resulting from the operation of a depiction decoder |
| | on an MPEG-4 depiction encoding or a VWR depiction encoding. |

Depiction Integrator Related Term Definitions

| Term | Definition |
|---|---|
| integrator | Functionality for interpreting and implementing an integration |
| | specification for an integration depiction collection, where the |
| | one or more depictions of the integration depiction collection |
| | are reconfigured in to a depiction encoding according to the |
| | integration specification, and where, for the stylistic |
| | components of the one or more expression styles of the |
| | integration specification, the expression style encodings of the |
| | depiction encoding for those stylistic components are encoded |
| | such that the depiction style of the depiction encoding includes |
| | those expression styles according to the integration |
| | specification. |
| integration specification | The rules for producing an integrated resultant, comprising |
| | rules controlling the reconfiguration of the integration |
| | depiction collection and rules for including the integration |
| | expression styles in the integrated resultant, and may |
| | additionally comprise rules specifying the accepted integration |
| | depiction collection configurations. |
| integration expression styles | The one or more expression styles of an integration |
| | specification. |
| integration package | A specification for producing an integrated resultant by an |
| | integrator, comprising an integration specification and a |
| | corresponding integration depiction collection. |
| integration depiction | An identification of one or more depictions, where a depiction |
| collection | comprises a depiction encoding, an integration package, or |
| | another expression of a narrative account which can be |
| | evaluated to a depiction encoding, and where the identification |
| | of each depiction is either the depiction or a reference to the |
| | depiction. |
| integrated resultant | The depiction encoding resulting from an integrator |
| | implementing an integration specification for an integration |
| | depiction collection. |

Integrator Supportive Term Definitions

| Term | Definition |
|---|---|
| superseder expression style | The higher priority expression style of the two expression |
| | styles which share a supersession stylistic component. |
| superseded expression style | The lower priority expression style of the two expression |
| | styles which share supersession stylistic component. |
| supersession stylistic component | The stylistic component equivalent to the minimum |
| | encompassing stylistic component of the difference |
| | between the mutually exclusive stylistic component |
| | portions of two expression styles, where the two |
| | expression styles consist of a higher priority expression |
| | style and a lower priority expression style, and where the |
| | priority indicates corresponding expression style |
| | implementation preference in the depiction. For |
| | example, given a first expression style comprising |
| | specifying a car color of red, and given a second |
| | expression style comprising specifying the color blue for |
| | the same car, the difference between the two expression |
| | styles is the color of the car, and this difference is |
| | mutually exclusive, as the car cannot be both colors. An |
| | encompassing stylistic component of this difference is |
| | the appearance of the car, but the minimum |
| | encompassing stylistic component is the car color, which |
| | would be the supersession stylistic component for these |
| | two example expression styles. |
| dependant integration | An integration specification which specifies an |
| specification | integration depiction collection which requires inclusion |
| | of a required depiction from a specified class of matching |
| | depictions. |
| required depiction | A depiction from the specified class of matching |
| | depictions of a dependant integration specification. |
| enable-able integration | An integration specification which specifies an |
| specification | integration depiction collection which may optionally |
| | include an enabling depiction from a specified class of |
| | matching depictions. |
| enabling depiction | A depiction from the specified class of matching |
| | depictions of an enable-able integration specification. |

Miscellaneous Term Definitions

| Term | Definition |
|---|---|
| subset | A set whose members are all members of some other set, |
| | including the case where all the members of said other set are |
| | also members of said set. |
| VWR | Short for Virtual World Rendered, refers to the method of |
| | generating a depiction of a narrative account from a virtual world |
| | simulation of that narrative account, where renderings are taken |
| | of the virtual world during the virtual world simulation |
| | operation, and where those renderings form the basis of the |
| | depiction. Examples may include use of a 3D video game |
| | engine for generating a depiction, use of the methods described |
| | in patent application number 11/676,922: “System and Method |
| | for the Production of Presentation Content Depicting a Real |
| | World Event”, or use of said patent application methods but with |
| | the restriction to only real world events removed. |
| presentation device | A device whose purpose includes producing sensory output |
| | detectable by at least one sense. Said device is connected to one |
| | or more sources of content for said device by a communication |
| | means, and produces said sensory output depending on said |
| | content. Examples of such a device include, but are not limited |
| | to, a visual sensory output device, or display device, such as a |
| | television or monitor, and an audible sensory output device, or |
| | sound output device, such as a stereo or surround sound system. |
| presentation content | Content in an encoding suitable for input to one or more |
| | presentation devices. |
| simulation | A virtual three dimensional reality generated by algorithms |
| | operating on one or more computational devices. A common |
| | example of a simulation is in a video game, where a virtual |
| | world is generated as a simulation by a computer. |
| rendering | The resultant output from an operation of a renderer. |
| presentation operation | The operation of producing a presentation of a depiction from a |
| | depiction encoding, comprising the operation of a depiction |
| | decoder decoding the depiction encoding, the operation of |
| | producing presentation content from the decoded depiction, and |
| | the operation of transmitting the presentation content to the |
| | presentation devices. |
| presentation initiation | The portion of the presentation operation where elements |
| | necessary for the presentation performance are made ready. |
| presentation performance | The portion of the presentation operation where the depiction is |
| | presented on the presentation devices, or the portion of the |
| | presentation operation where the presentation content is |
| | produced. |
| presentation termination | The portion of the presentation operation occurring after the |
| | presentation performance. |
| simulator | The process of operating a simulation. |
| renderer | The process of converting an aspect of a simulation into a form |
| | compatible with a presentation device of a given type and |
| | capability. A typical render operation may be the conversion of |
| | the view from a given position in a given direction within a |
| | simulation to a form suitable for transmission to a display device, |
| | or the conversion of the soundscape from a given position in a |
| | given direction within a simulation to a form suitable for |
| | transmission to a sound output device. |
| presentation system | The system generating a presentation, including operating the |
| | presentation operation and transmitting presentation content to |
| | the presentation devices. |
| rendering frustum | The region of space within the simulation from which a |
| | rendering is generated from. The exact shape of this region |
| | varies depending on the specifics of the rendering. For example, |
| | for a rendering for a display device it is the region of the |
| | simulation that may appear on the screen, commonly referred to |
| | as the field of view of the notional camera, and commonly the |
| | shape of this region varies depending on what kind of camera |
| | lens is being simulated, but typically it is a frustum of a |
| | rectangular pyramid. |

Real World Event and Virtual World Simulation Related Term Definitions

| Term | Definition |
|---|---|
| real world clock time span | A span of clock time, bound by a start clock time and an end |
| | clock time, where said span is formed from a measurement of |
| | real world time, a duration of real world time, and an offset of |
| | real world time, such that said start clock time is equal to the |
| | sum of said measurement and said offset, and such that said end |
| | clock time is equal to the sum of said measurement, said offset, |
| | and said duration, and where said offset is either implicit or is |
| | explicitly measured, and where said duration is either implicit or |
| | is explicitly measured, and where said start clock time and said |
| | end clock time implicitly, explicitly, or effectively share a |
| | common time scale. Examples include, but are not limited to, |
| | 5/16/2006 1:45 PM to 5/16/2006 3:00 PM local time, and |
| | 5/16/2006 05:47:32.843 UTC with an implicit error range of plus |
| | or minus 4 milliseconds. Examples of said time scale include, |
| | but are not limited to, Greenwich Mean Time, Coordinated |
| | Universal Time, the local time scale of some time zone, or some |
| | time scale based on one or more clocks. |
| real world object | A physical object in the real world. Examples include, but are |
| | not limited to, a solid, liquid, or gas body, or some collection of |
| | said bodies, such as a car, a person, the surface of an area of |
| | land, a road, a body of water, and a volume of air above an area |
| | of land. |
| real world measurable | A measurable quality of a real world object. Examples include, |
| quality | but are not limited to, size, mass, location, direction, velocity, |
| | acceleration, pressure, temperature, electric field, magnetic field, |
| | and many other physical properties of a real world object. |
| real world measurement | The value of a measurement of a real world quality of a real |
| | world object over a real world clock time span, or a composite |
| | measurement from a plurality of measurements of a real world |
| | quality of a real world object over a real world clock time span, |
| | where the value of said composite measurement and the |
| | corresponding real world clock time span of said composite |
| | measurement are calculated using interpolation, extrapolation, |
| | curve fitting, averaging, or some other algorithm, from said |
| | plurality of measurements. Examples include, but are not limited |
| | to, measurement of the location of a particular vehicle at a |
| | particular time, or a plurality of such measurements for said |
| | vehicle over a time span, and interpolating between said |
| | measurements using said time span to calculate said vehicle |
| | position at a particular time within said time span. Example uses |
| | of composite measurements include, but are not limited to, |
| | obtaining a likely measurement at a time when no measurement |
| | was actually made, such as at a time between two measurements, |
| | or to increase the accuracy of a measurement by averaging a |
| | plurality of measurements, or to increase or decrease the rate of |
| | measurements to a desired rate. For example, a measurement of |
| | position of an object made at a rate of 75 times per second may |
| | be reduced to a measurement rate of 60 times per second. |
| real world event | A real world clock time span and a set of one or more real world |
| | objects, where for each said real world object there is set of real |
| | world measurements, where the real world clock time span for |
| | each said real world measurement is within said real world clock |
| | time span of the real world event. Examples include a motor |
| | sports event, where the position of the participating vehicles are |
| | measured at regular intervals during the duration of the event, or |
| | a sail boat race, where the position, hull speed, and air speed and |
| | direction of the participating boats, and the water current speed |
| | and direction at a set of fixed locations, and the air speed and |
| | direction at a set of fixed locations, are all measured at regular |
| | intervals during the duration of the event. |
| real world measurement | The virtual world value of a virtual world quality of a virtual |
| based virtual world value | world object over a virtual world clock time span, where said |
| | virtual world value reflects a real world measurement, and where |
| | said virtual world measurable quality corresponds to the real |
| | world quality of said real world measurement, and where said |
| | virtual world object corresponds to the real world object of said |
| | real world measurement, and where said virtual world clock time |
| | span corresponds to the real world clock time span of said real |
| | world measurement. |
| virtual world clock time | A span of virtual clock time, bound by a start virtual clock time |
| span | and an end virtual clock time, within the virtual three |
| | dimensional reality of a simulation. The virtual three |
| | dimensional reality equivalent to the definition of real world |
| | clock time span for the real world. Examples include, but are not |
| | limited to, a representation within a simulation of a real world |
| | clock time span. |
| virtual world object | A virtual physical object within the virtual three dimensional |
| | reality of a simulation. The virtual three dimensional reality |
| | equivalent to the definition of real world object for the real |
| | world. Examples include, but are not limited to, a representation |
| | within a simulation of a real world object, such as a race track, a |
| | vehicle, a body of water, a building or other structure, the surface |
| | features of an area of land, or a volume of air, or a version of any |
| | of those example objects which are not real world objects. |
| virtual world measurable | A virtual measurable quality of a virtual world object. The |
| quality | virtual three dimensional reality equivalent to the definition of |
| | real world measurable quality for the real world. Examples |
| | include, but are not limited to, a representation within a |
| | simulation of a real world measurable quality. |

1. A computer implemented method for constructing a depiction encoding from at least one depiction, the method comprising the steps of:
providing at least one depiction;
selecting at least one encoding collection which encodes a narrative account from the at least one depiction;
constructing at least one subsequent encoding collection from the at least one selected encoding collection, whereby at least one expression style is optionally superseded in the at least one subsequent encoding collection; and
assembling a subsequent depiction encoding from the at least one subsequent encoding collection.

2. The method of claim 1, where the subsequent depiction encoding has a depiction encoding form for a VWR depiction decoder.

3. The method of claim 1, wherein the narrative account of the subsequent depiction encoding comprises a real world event.

4. The method of claim 1, where in the method operates in conjunction with a depiction decoder decoding the subsequent depiction encoding.

5. The method of claim 1, where an expression style is superseded in a subsequent encoding collection using an expression style encoding produced by an automated producer.

6. The method of claim 1, where the subsequent depiction encoding is stored on a data storage device or transmitted to a receiver using a data communication means.

7. The method of claim 1, where the subsequent depiction encoding is produced for a presentation in response to a user request for the presentation.

8. The method of claim 1, where the subsequent depiction encoding is produced according to an integration specification.

9. The method of claim 8, where the integration specification specifies the priority of a plurality of overlapping expression styles, where the overlap comprises a shared stylistic component from the plurality of overlapping expression styles.

10. The method of claim 8, where the integration specification specifies criteria for determining if the configuration of depictions is a valid configuration of depictions.

11. The method of claim 10, where the integration specification criteria specify a plurality of valid configurations of depictions, where at least one valid configuration of depictions comprises a depiction which encodes a narrative account, such that the narrative account is not encoded in any depiction of at least one other valid configuration of depictions.

12. The method of claim 10, where the integration specification criteria specify a narrative account, such that all valid configurations of depictions comprise a depiction encoding the narrative account.

13. The method of claim 8, where the integration specification is represented as part of a numerical data set, and where the numerical data set is stored on a data storage device, retrieved from a data storage device, transmitted using a data communication means, or received using a data communication means.

14. The method of claim 13, where the numerical data set includes at least one depiction.

15. The method of claim 8, where the integration specification is created according to one or more user specified selections via a human interface device.

16. The method of claim 8, where the integration specification is created as a result of modifications made to another integration specification according to user specified selections.

17. The method of claim 8, where an integration specification specifies user specified selection restrictions for one or more elements of the integration specification, where each restriction specifies that the element is modifiable, is not modifiable, or the range of allowable modifications.

18. The method of claim 16, where the modifications occur during a presentation of the subsequent depiction encoding.

19. The method of claim 8, where a plurality of integration packages are indicated to the user, and where an integration package is selected by the user, and where the integration package is the basis of the integration specification and depictions.

20. The method of claim 19, where the selected integration package is modified according to one or more user specified selections.

21. The method of claim 8, where a first integration specification and a first configuration of depictions is selected by a user for a presentation, and where a set of rules determine the establishment of the integration specification and a configuration of depictions based on the first integration specification and first configuration of depictions.

22. The method of claim 8, where the integration specification includes rules controlling DRM restrictions on unauthorized copying or unauthorized use of one or more of the integration specification, one or more depictions, or the subsequent depiction encoding.

23. The method of claim 8, where the integration specification includes rules controlling DRM restrictions on the allowed depictions.

24. The method of claim 8, where the integration specification of a depiction includes rules controlling DRM restrictions on use of one or more of the integration specification of the depiction, or one or more of the depictions of the integration depiction collection of the depiction.

25. The method of claim 8, where the integration specification includes rules controlling DRM restrictions on the allowable modifications of one or more of the integration specification, one or more depictions, or the subsequent depiction encoding.

26. A system for constructing a depiction encoding from one or more depictions, the system comprising:
a computational operating mechanism having:
receiving at least one depiction;
selecting at least one encoding collection which encodes a narrative account from the at least one depiction;
constructing at least one subsequent encoding collection from the at least one selected encoding collection, whereby at least one expression style is optionally superseded in the at least one subsequent encoding collection;
assembling a subsequent depiction encoding from the at least one subsequent encoding collection; and
storing the subsequent depiction encoding.

27. The system of claim 26, further comprising: one or more presentation devices, and a mechanism for producing presentation content for the one or more presentation devices from the subsequent depiction encoding, and a transmission mechanism for transmitting the presentation content to the one or more presentation devices.

28. A computer program product for constructing a depiction encoding from one or more depictions, comprising:
computer code that receives at least one depiction;
computer code that selects at least one encoding collection which encodes a narrative account from the at least one depiction;
computer code that constructs at least one subsequent encoding collection from the at least one selected encoding collection, whereby at least one expression style is optionally superseded in the at least one subsequent encoding collection;
computer code that assembles a subsequent depiction encoding from the at least one subsequent encoding collection; and
a computer readable medium that stores the computer codes.

29. The computer program product of claim 28, wherein the computer readable medium is a CD-ROM, DVD-ROM, tape, flash memory, system memory, hard drive, or a data signal embodied in a carrier wave.

30. The method of claim 1, wherein the subsequent depiction encoding comprises a set of real world measurement based virtual world values for each real world object from a real world event.
